(19) United States
(12) Patent Application Publication
(10) Pub. No.: US 2008/0310391 A1
(43) Pub. Date: Dec. 18, 2008

(54) APPARATUS FOR AND METHOD OF POWER SAVE TRAFFIC CONTROL IN CLIENT/SERVER NETWORKS

(75) Inventors: Alexander Schneidman, Natanya (IL); Yoel Boger, Shoham (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/764,212

(22) Filed: Jun. 17, 2007

(51) Int. Cl. H04J 3/24

(52) U.S. Cl. 370/349

(57) ABSTRACT

A novel and useful apparatus for and method of handling traffic congestion during power save mode in client/server systems such as wireless local area networks (WLANs). A reduction in response time is achieved by minimizing communications between the host and the MAC processing entities in client devices. The host sends shortened descriptors to the MAC rather than complete frames. Only a limited number of frames for each client queue are stored on the MAC. A transfer bitmap is used to track the frames to be transferred from the host to the MAC. Transmitter pre-processing is performed on the frames pulled from the host. A transmit bitmap is used to track frames that have been processed and awaiting transmission to a client. Frames that are ready are then sent out from queues for clients that are active and have an ongoing service period.

### FIELD OF THE INVENTION

The present invention relates to the field of data communications and more particularly relates to an apparatus for and method of handling traffic congestion during power save mode in client/server systems such as wireless local area networks (WLANs).

### BACKGROUND OF THE INVENTION

Currently, the trend of anytime, anywhere computing and communication is growing at an ever quicker pace. Wireless communication technology coupled with the available of light weight, powerful, compact and portable computing devices is largely responsible for this rapidly increasing trend. Mobile ad hoc networks (MANETs) are one type of network commonly used to provide anywhere computing. A MANET is a network comprising a number of mobile stations that are able to communicate with each other that do not utilize a base station.

A critical factor for the deployment and use of MANETs, and portable devices in general, is battery power. The power supplied by the batteries within the devices is a limited resource and device designers are constantly devising ways to lengthen the life of batteries. A wireless local area network (WLAN) is one such MANET that relies heavily on batteries for its operation.

A wireless local area network (WLAN) links two or more computers together without using wires. WLAN networks utilize spread-spectrum technology based on radio waves to enable communication between devices in a limited area, also known as the basic service set. This gives users the mobility to move around within a broad coverage area and still be connected to the network.

For the home user, wireless networking has become popular due to the ease of installation and location freedom with the large gain in popularity of laptops. For the business user, public businesses such as coffee shops or malls have begun to offer wireless access to their customers, whereas some are even provided as a free service. In addition, relatively large wireless network projects are being constructed in many major cities.

There are currently there exist several standards for WLANs: 802.11, 802.11a, 802.11b, 802.11 g and 802.11n. The 802.11b has a rate of 11 Mbps in the 2.4 GHz band and implements direct sequence spread spectrum (DSSS) modulation. The 802.11a is capable of reaching 54 Mbps in the 5 GHz band. The 802.11g standard also has a rate of 54 Mbps but is compatible with 802.11b. The 802.11a/g implements orthogonal frequency division multiplexing (OFDM) modulation.

A wireless ad hoc network is a computer network in which the communication links are wireless, The network is termed ad hoc because each node is able to forward data for other nodes wherein the decision to which nodes forward data is made dynamically based on the particular network connectivity. This is in contrast to legacy network technology in which some designated nodes, usually comprising custom hardware and known as routers, switches, hubs and firewalls, perform the task of forwarding the data. Minimal configuration and quick deployment make ad hoc networks suitable for emergency situations like natural or human-induced disasters, military conflicts, emergency medical situations, etc.

A network diagram illustrating an example prior art wireless client/server network is shown in FIG. 1. The example network, generally referenced 10, comprises a base station or server 16 coupled to a wired LAN 14 such as an Ethernet network and a plurality of wireless client devices 12. The client/server system may comprise, for example, a WLAN network wherein the server comprises a WLAN access point (AP) and the clients comprise WLAN stations (STAs).

A WLAN station is any component that can connect into a wireless medium in a network. All stations are equipped with wireless network interface cards (NICs) and are either access points or clients. Access points (APs) are base stations for the wireless network. They transmit and receive radio frequencies for wireless enabled devices to communicate with. Wireless clients can be mobile devices such as laptops, personal digital assistants, IP phones or fixed devices such as desktops and workstations that are equipped with a wireless network interface card.

The basic service set (BSS) is defined as the set of all stations that can communicate with each other. There are two types of BSS: (1) independent BSS and (2) infrastructure BSS. Every BSS has an identification (ID) called the BSSID, which is the MAC address of the access point servicing the BSS. An independent basic service set (BSS) is an ad hoc network that contains no access points, which means the stations within the ad hoc network cannot connect to any other basic service set.

An infrastructure basic service set (BSS) can communicate with other stations that are not in the same basic service set by communicating through access points. An extended service set (ESS) is a set of connected BSSs. Access points in an ESS are connected by a distribution system. Each ESS has an ID called the SSID which is a 32-byte (maximum) character string. A distribution system connects access points in an extended service set. A distribution system is usually a wired LAN but can also be a wireless LAN.

The types of wireless LANs include peer to peer or ad hoc wireless LANs. A peer-to-peer (P2P) WLAN enables wireless devices to communicate directly with each other. Wireless devices within range of each other can discover and communicate directly without involving central access points. This method is typically used by two computers so that they can connect to each other to form a network. If a signal strength meter is used in this situation, it may not read the strength accurately and can be misleading, because it registers the strength of the strongest signal, which may be the closest computer.

The IEEE 802.11 standard provides for two modes of operation: an active mode and a power saving (PS) mode. Power saving (PS) mode is a power efficient method that prolongs the network operation time of battery powered wireless LAN devices. It is a synchronous protocol which requires precise time synchronization among all the participating stations within the Independent Basic Service Set (IBSS). Therefore, a Time Synchronization Function (TSF) is defined for the protocol to operate without the aid of external timing sources. The standard assumes the stations are time synchronized and thus all PS stations will wake up at about the same time.

Time synchronization is achieved by periodically transmitting a time synchronization beacon, which defines a series of fixed length beacon intervals. The successful beacon serves to synchronize the clocks of the stations in the ad hoc network. The beacon also inhibits other stations from transmitting their beacons. In order to avoid collisions among beacons, stations wait a random number of slots (i.e. backoff period) before transmitting a beacon.

In PS mode for Distributed Coordinated Function (DCF), stations wake up at the beginning of each beacon interval for a time duration window referred to as the Announcement Traffic Indication Message (ATIM) window to announce their pending data packets using small ATIM control packets. The station remains awake for the entire remaining period after transmitting an ATIM frame. Upon reception of an ATIM frame, the power save station replies with an ACK and remains active for the remaining period. After the ATIM window ends, stations transmit the announced data packets using contention based DCF access procedures. If the sender does not receive an ACK, it retries transmission in the next ATIM window.

With reference to FIG. 1, in many communication systems a number of the mobile client devices are adapted to operate on battery power. In these battery operated devices, power consumption is of great concern. Unscheduled delivery of frames is one prior art scheme proposed to solve the power consumption problem. In this scheme, the client is in sleep mode for the majority of the time. Such a client is referred to as a sleepy or sleeping client. When it comes time for the client to send one or more packets, it wakes up and transmits the packets to the server (i.e. base station or access point in WLAN systems).

Reception of a packet (i.e. a trigger message) from a sleeping client constitutes a trigger event. Such an event notifies the server that the client is awake and ready to receive packets. The server starts to send packets until some predefined limit or until it exhausts all messages it had buffered for that client. The server marks the last message to indicate to the client that it can return to sleep without loosing any data from the server.

In such client/server systems, it is desirable to minimize the time that the client waits to receive messages from the server. The time from reception of a trigger to the time the server has a frame ready for transmission to the client is called the response time (assuming that the server has a buffered frame to the client and the only delay is due to processing). To illustrate, in a typical voice application the client wakes up every 20 ms to send a single voice packet. Typically, the server has one or two packets buffered for the client that it sends upon receiving a trigger. With a response time of 15 ms, the client sleeps 25% of the time. If, however, the response time is reduced to 1 ms, the client sleeps 95% of the time with permits a much longer battery life.

A typical system comprises the server 16 and multiple clients 12 connected to it. Note that at any instant in time, a portion of the clients are asleep. For example, an access point in a WLAN can support more than 2000 clients connected simultaneously.

Embedded server architecture usually includes two processors, namely a host processor and a separate MAC processor. An example network illustrated this is shown in FIG. 2 wherein the base station, generally referenced 20, comprises an antenna 22, host processor 26, MAC processor 24, host memory 28, MAC memory 29 and a host-MAC communication bus 23.

In operation, the host 26 implements upper layer protocols, such as the network TCP/IP stack, FTP server, etc and runs user applications, such as a Web browser, voice application, Outlook, etc. The host also operates under ‘soft’ real time constraints and has access to a relatively large amount of host memory 28. The MAC processor implements the media specific protocol, e.g., WLAN, WiMax, GSM, etc., operates under ‘hard’ real time constraints and has a relatively small limited amount of memory. A communication bus 23, which sometimes can be quite slow, connects the two processors.

Considering the memory limitation of the MAC processor, in prior art systems, the host processor buffers messages destined to sleeping clients. The power state indicating whether a client is in active or power save mode for each client attached to the server is maintained by the host. If the client is in power save, the host waits for a trigger from the client before sending it any buffered frames. Upon receipt of a trigger notification from the MAC processor it starts to send buffered messages to the MAC for transmission to the client.

A problem arises as the communication bus can be very slow or the host can be very busy serving different applications, which adversely effects the response time. In a typical WLAN system, the response time can be as long as 5-10 ms. Even worse, this time can increase significantly if triggers from two sleeping clients arrive in close proximity to each other.

Thus a big drawback of this prior art scheme is that it may not be suitable for clients that are sensitive to power consumption and which enter power save mode frequently (e.g., battery powered mobile embedded platforms), since it keeps the client awake for a relatively long time period for each trigger sent.

The delays in transferring data from the server to the host are mostly due to unacceptably long host processing of the trigger frame and buffered frame transfer to the MAC memory. Another major reason for the delay is the latency of the transmit processing, whereby the queue in which the buffered frame is placed may already contain frames designated to other clients that are to be processed before it. In this case, the overhead is significant since the MAC will handle the buffered frame only once all the previous frames are handled.

Thus, there is a need for a power save traffic control mechanism that overcomes the disadvantages of the prior art and provides the ability to significantly reduce the time delay in transmitting frames from the server to power save capable clients while avoiding congestion and avoiding any denial of service for clients.

### SUMMARY OF THE INVENTION

The present invention is a novel and useful apparatus for and method of handling traffic congestion during power save mode in client/server systems such as wireless local area networks (WLANs). The power save traffic control mechanism of the present achieves a significant reduction in the response time for power save enabled client devices to receive frames after sending a trigger to the base station (or server). The trigger is sent by the client to the server after it awakes from sleep mode.

A reduction in response time is achieved by a combination of several factors including the following. The communication between the host and the MAC processing entities are minimized in client devices. The host sends shortened descriptors to the MAC rather than complete frames. Further, only a limited number of frames for each client queue are stored on the MAC. In addition, the MAC is aware of and tracks sleeping clients rather than the host. To track the frames to be transferred from the host to the MAC, a transfer bitmap is used wherein each bit represents a frame to be pulled from the host. Transmitter pre-processing is performed on the frames pulled from the host and stored in the MAC. A transmit bitmap is used to track frames that have been processed and are awaiting transmission to a client. Frames that are ready are then sent out from queues for clients that are active and have an ongoing service period.

Although the mechanism of the present invention can be used in numerous types of communication systems, to aid in illustrating the principles of the present invention, the description of the power save traffic control mechanism is provided in the context of a WLAN access point in communication with a plurality of power save enabled STAs, i.e. a basic service set (BSS) radio.

Although the power save traffic control mechanism of the present invention can be incorporated in numerous types of systems such as a multimedia player, cellular phone, PDA, etc., it is described in the context of a access point. It is appreciated, however, that the invention is not limited to the example applications presented, whereas one skilled in the art can apply the principles of the invention to other client/server communication systems as well without departing from the scope of the invention.

The power save traffic control mechanism has several advantages including the following: (1) using bitmaps to track and maintain transfer and transmit operations is both memory and CPU efficient, as most modern CPU kernels support bitmap operations in a single instruction cycle; (2) the mechanism is scalable and supports an arbitrary number of clients; (3) the mechanism minimizes the time required for an access point to respond to a trigger event.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as Nucleus, ThreadX, WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the invention, a method of traffic control during power save in a system of a plurality of power save enabled client devices and a server, the server having a host and a media access control (MAC), the method comprising the steps of receiving descriptors on the MAC sent from the host, wherein each descriptor identifies a frame stored on the host and a client associated therewith and utilizing a bitmap in the MAC to indicate the frames to be retrieved from the host and the transferred frames ready to be transmitted to a client.

There is also provided in accordance with the invention, a method of power save traffic control in a system of a plurality of power save enabled client devices and a server, the server having a host and a media access control (MAC), the method comprising the steps of receiving frame descriptors from the host, wherein each frame descriptor identifies a frame stored on the host and a client associated therewith and transferring from the host to the MAC a predetermined number of frames corresponding to received frame descriptors for sleeping clients and storing them in frame buffers, transferring from the host to the MAC a sufficient number of frames corresponding to received frame descriptors for active clients to provide a continuous flow of frames thereto and storing them in the frame buffer and utilizing a bitmap to indicate which client queues have frame buffers ready to transmit.

There is further provided in accordance with the invention, a method of minimizing traffic congestion in a system of power save client devices in communication with a server, the method comprising the steps of receiving shortened message descriptors from the host and storing them in respective MAC queues, wherein each message descriptor identifies a buffer stored on the host and a client device associated therewith, indicating via a transfer bitmap the client queues with buffers to be transferred from the host to the MAC, transferring buffers from the host to the MAC in accordance with the transfer bitmap and storing them in MAC memory, processing contents of the buffers to yield processed buffers ready for transmission and indicating via a transmit bitmap the client queues having buffers ready to transmit.

There is also provided in accordance with the invention, a media access control (MAC) for use in a base station server in communication with a plurality of power save enabled client devices comprising a transfer bitmap for storing indications of client queues for which buffers are to be transferred from a host, a transmit bitmap for storing indications of client queues having buffers ready to transmit, a plurality of frame buffers for storing complete frames, a power save traffic congestion module operative to receive shortened message descriptors from the host, wherein each message descriptor identifies a buffer stored on the host and a client associated therewith, update the transfer bitmap in accordance with the message descriptors received and the status of each client corresponding thereto, retrieve client queue buffers from the host in accordance with the bits set in the transfer bitmap and storing them in the frame buffers, preprocess buffers retrieved from the host in preparation for transmission and update the transmit bitmap in accordance with the preprocessed buffers ready to transmit.

There is further provided in accordance with the invention, a wireless access point comprising a radio frequency (RF) front end circuit coupled to an antenna, a PHY circuit coupled to the RF front end circuit, a baseband processor coupled to the PHY circuit, a media access control (MAC) coupled to the baseband processor, the MAC comprising means for receiving shortened message descriptors from a the host, wherein each message descriptor identifies a buffer stored on the host and a client associated therewith, means for updating a transfer bitmap in accordance with the message descriptors received and the status of each client corresponding thereto, means for retrieving client queue buffers from the host in accordance with the bits set in the transfer bitmap and storing them in frame buffers, means for preprocessing buffers retrieved from the host in preparation for transmission, means for updating a transmit bitmap with the preprocessed buffers ready to transmit and the host operative to interface the access point to an external network.

### BRIEF DESCRIPTION OF THE DRAWINGS

The invention is herein described, by way of example only, with reference to the accompanying drawings, wherein:

FIG. 1 is a network diagram illustrating an example prior art wireless client/server network;

FIG. 2 is a network diagram illustrating the base station (or server) device of FIG. 1 in more detail;

FIG. 3 is a block diagram illustrating an example base station incorporating the power save traffic control mechanism of the present invention;

FIG. 4 is a diagram illustrating the transfer active service period bitmap of the present invention;

FIG. 5 is a diagram illustrating the transmit active service period bitmap of the present invention;

FIG. 6 is a flow diagram illustrating the method of the present invention for transferring buffers from the host to the MAC;

FIG. 8 is a flow diagram illustrating the frame transfer method of the present invention;

FIG. 9 is a flow diagram illustrating the frame transmit preprocessing method of the present invention;

FIG. 9 is a flow diagram illustrating the buffer transmission method of the present invention;

FIG. 10 is a flow diagram illustrating client sleep notification method of the present invention;

FIG. 11 is a block diagram illustrating an example WLAN access point incorporating the power save traffic control mechanism of the present invention;

FIG. 12 is a block diagram illustrating the MAC portion of the WLAN access point of FIG. 11 in more detail;

FIG. 13 is a diagram illustrating the message flow in the case of an active client;

FIG. 14 is a diagram illustrating the message flow in the case of a sleeping client and low priority flow; and

FIG. 15 is a diagram illustrating the message flow in the case of a sleeping client and high priority flow.

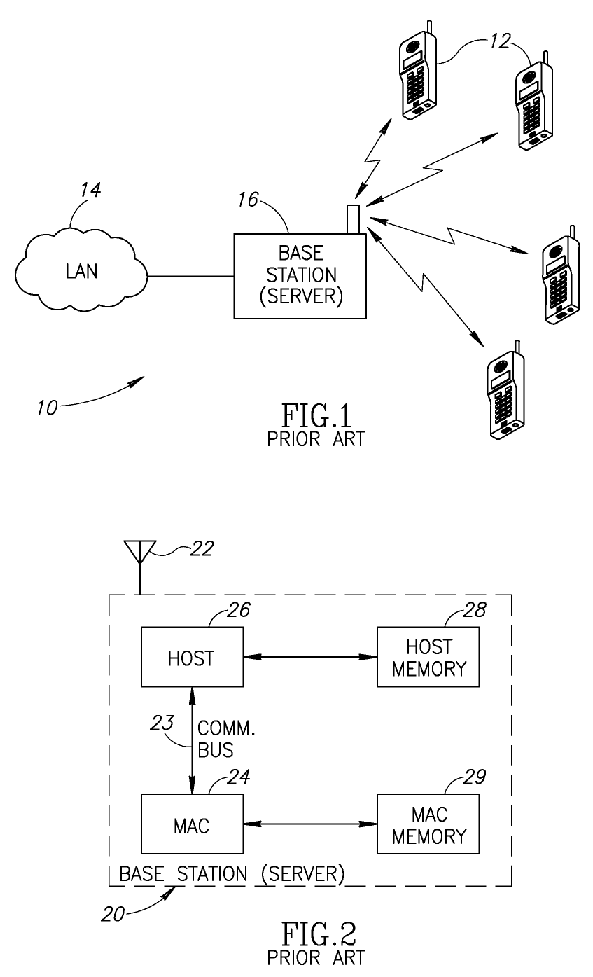

### DETAILED DESCRIPTION OF THE INVENTION

### Notation Used Throughout

The following notation is used throughout this document.

| Term | Definition |
|---|---|
| ADC | Analog to Digital Converter |
| AP | Access Point |
| ASIC | Application Specific Integrated Circuit |
| ASPB | Active Service Period Bitmap |
| ATIM | Announcement Traffic Indication Message |
| AVI | Audio Video Interleave |
| BMP | Windows Bitmap |
| BSS | Basic Service Set |
| CPU | Central Processing Unit |
| DAC | Digital to Analog Converter |
| DCF | Distributed Coordinating Function |
| DoS | Denial of Service |
| DSP | Digital Signal Processor |
| DSSS | Direct Sequence Spread Spectrum |
| EEPROM | Electrically Erasable Programmable Read Only Memory |
| EPROM | Erasable Programmable Read Only Memory |
| ESS | Extended Service Set |
| FEM | Front End Module |
| FPGA | Field Programmable Gate Array |
| FTP | File Transfer Protocol |
| GPS | Ground Positioning Satellite |
| GSM | Global System for Mobile communication |
| HDL | Hardware Description Language |
| IBSS | Independent Basic Service Set |
| ID | Identification |
| IEEE | Institute of Electrical and Electronics Engineers |
| IF | Intermediate Frequency |
| IP | Internet Protocol |
| JPG | Joint Photographic Experts Group |
| LAN | Local Area Network |
| MAC | Media Access Control |
| MANET | Mobile Ad Hoc Network |
| MP3 | MPEG-1 Audio Layer 3 |
| MPG | Moving Picture Experts Group |
| MSB | Most Significant Bit |
| NIC | Network Interface Card |
| OFDM | Orthogonal Frequency Division Multiplexing |
| P2P | Peer to Peer |
| PCI | Personal Computer Interconnect |
| PDA | Portable Digital Assistant |
| PDU | Protocol Date Unit |
| PS | Power Save |
| QoS | Quality of Service |
| RAM | Random Access Memory |
| RF | Radio Frequency |
| ROM | Read Only Memory |
| SSID | Service Set Identifier |
| STA | Station |
| TCP | Transmission Control Protocol |
| TSF | Time Synchronization Function |
| TX-ASPB | Transmit Active Service Period Bitmap |
| USB | Universal Serial Bus |
| UWB | Ultra Wideband |
| WiFi | Wireless Fidelity |
| WiMax | Worldwide Interoperability for Microwave Access |
| WiMedia | Radio platform for UWB |
| WLAN | Wireless Local Area Network |
| WMA | Windows Media Audio |
| WMV | Windows Media Video |
| XFR-ASPB | Transfer Active Service Period Bitmap |

### DETAILED DESCRIPTION OF THE INVENTION

The present invention is a novel and useful apparatus for and method of handling traffic congestion during power save mode in client/server systems such as wireless local area networks (WLANs). The power save traffic control mechanism of the present achieves a significant reduction in the response time for power save enabled client devices to receive frames after sending a trigger to the base station (or server). The trigger is sent by the client to the server after it awakes from sleep mode.

A reduction in response time is achieved by a combination of several factors including the following. The communication between the host and the MAC processing entities are minimized in client devices. The host sends shortened descriptors to the MAC rather than complete frames. Further, only a limited number of frames for each client queue are stored on the MAC. In addition, the MAC is aware of and tracks sleeping clients rather than the host. To track the frames to be transferred from the host to the MAC, a transfer bitmap is used wherein each bit represents a frame to be pulled from the host. Transmitter pre-processing is performed on the frames pulled from the host and stored in the MAC. A transmit bitmap is used to track frames that have been processed and are awaiting transmission to a client. Frames that are ready are then sent out from queues for clients that are active and have an ongoing service period.

Although the mechanism of the present invention can be used in numerous types of communication systems, to aid in illustrating the principles of the present invention, the description of the power save traffic control mechanism is provided in the context of a WLAN access point in communication with a plurality of power save enabled STAs, i.e. a basic service set (BSS) radio.

Although the power save traffic control mechanism of the present invention can be incorporated in numerous types of systems such as a multimedia player, cellular phone, PDA, etc., it is described in the context of a access point. It is appreciated, however, that the invention is not limited to the example applications presented, whereas one skilled in the art can apply the principles of the invention to other client/server communication systems as well without departing from the scope of the invention.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMax, WiMedia, WiFi, or any other broadband medium, etc. Examples of wired media include twisted pair, coaxial, optical fiber, any wired interface (e.g., USB, Firewire, Ethernet, etc.).

The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably. The terms packet, frame, message, protocol date unit (PDU) are used interchangeably and defined as a container or vessel used to convey data. The term ‘response time’ is defined as the time from reception of a trigger to the time the server has a frame ready for transmission to the client. Note that this assumes the server has a frame buffered ready to transmit to the client and the delay is only due to processing delays.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Base Station Incorporating the Power Save Traffic Control Mechanism

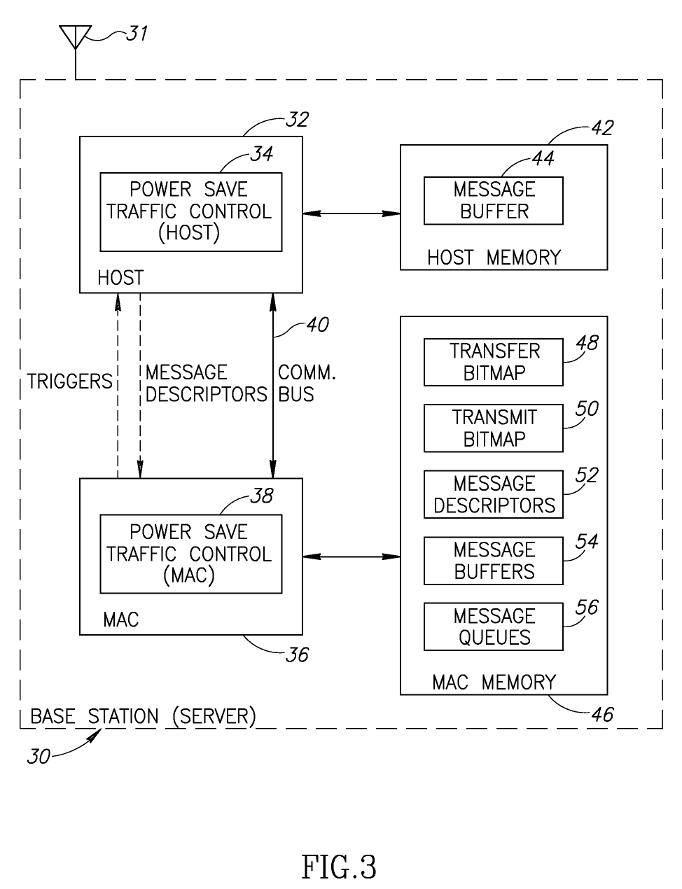

A block diagram illustrating an example base station incorporating the power save traffic control mechanism of the present invention is shown in FIG. 3. The base station (or server, access point, etc.), generally referenced 30, comprises a host processor 32, host memory 42 comprising a plurality of message (or frame) buffers 44, MAC processor 36, MAC memory 46 comprising a transfer bitmap 48, transmit bitmap 50, message descriptors memory 52, message buffers 54 and message queues 56 and antenna 31.

In operation, the host is operative to implement the host portion 34 of the power save traffic control mechanism of the present invention. Similarly, the MAC is operative to implement the MAC portion 38 of the power save traffic control mechanism of the present invention. The host and MAC processors communicate via a communication bus 40.

The power save traffic control mechanism of the invention is operative to minimize the response time thereby increasing battery/device life time in systems having limited MAC memory resources. First, the mechanism provides for quick response time. In an example implementation of the invention, the response time was able to be dramatically reduced from 6 ms to 100 us. In addition, the mechanism avoids the occurrence of any denial-of-service (DoS) that likely occurs if too many buffers need to be buffered for sleeping clients. The small MAC memory size in typical wireless server devices can very quickly cause congestion.

To reduce the response time, in accordance with the invention, all power saving logic is handled by the MAC processor. Typically, the MAC executes a fixed number of tasks with known processing time bounds (i.e. ‘hard’ real time) and thus can assure fixed response time to a trigger. In accordance with the mechanism of the invention, the host is unaware of the power-save state of its clients.

One problem that may arise from this approach is that the host assumes that all clients are active ones and sends messages to the MAC without any buffering. This is likely to cause congestion of MAC memory leading to denial of service, as the MAC will have to buffer frames for sleeping clients. A second problem is that the MAC must discriminate between clients. In prior art schemes, frames receives from the host were transmitted immediately. The MAC must not distinguish between frames. In Quality of Service (QoS) systems this requires the MAC to manage multiple queues.

### Power Save Traffic Control Mechanism

In order to avoid having to store multiple buffers, the host sends shortened message descriptors to the MAC rather than full frame buffers. A message descriptor comprises fields for identifying the frame buffer and the client and fields for conveying any other implementation-specific parameters. For example, in the example WLAN system presented herein a 64 byte descriptor is used that represents a 1500 byte frame buffer that is initially stored on the host. Frame buffers remain on the host until they are explicitly pulled by the MAC.

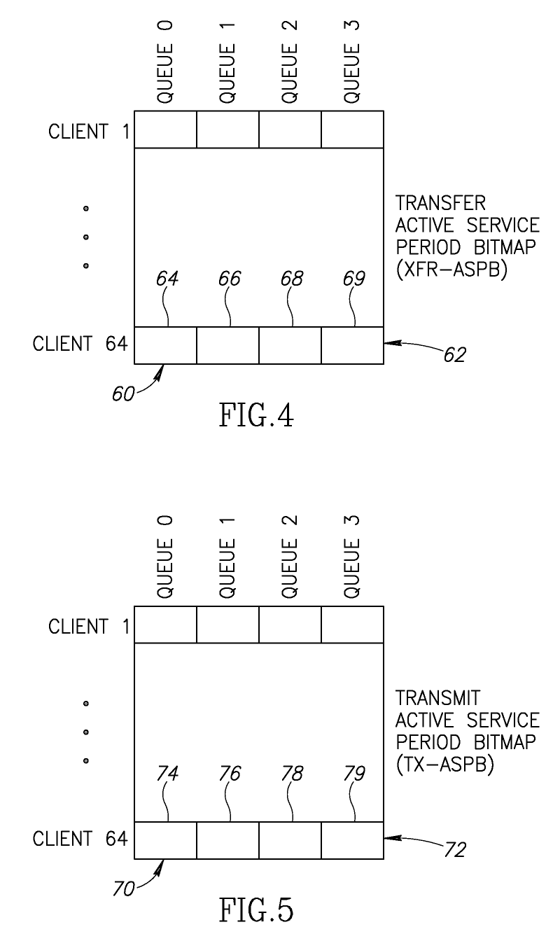

A diagram illustrating the transfer active service period bitmap of the present invention is shown in FIG. 4. The transfer active service period bitmap (XFR-ASPB) referred to simply as the transfer bitmap, generally referenced 60, comprises a bit for each client queue. In the example presented herein, the server is adapted to handle up to 64 clients 62. Each client, however, also handles Quality of Service (QoS) priorities comprising four queues per client (64, 66, 68, 69). Thus, the transfer bitmap comprises 256 bits. The transfer bitmap is used to monitor and track the state of descriptors. A bit is set in the transfer bitmap when a complete frame buffer is to be transferred from the host to the MAC memory.

A diagram illustrating the transmit active service period bitmap of the present invention is shown in FIG. 5. The transmit active service period bitmap (TX-ASPB) referred to simply as the transmit bitmap, generally referenced 70, comprises a bit for each client queue. In the example presented herein, the server is adapted to handle up to 64 clients 72. Each client, however, also handles Quality of Service (QoS) priorities comprising four queues per client (74, 76, 78, 79). Thus, the transmit bitmap comprises 256 bits. Note that an implementation of the invention may add additional queues, not related directly to a particular client. For example, in WLAN systems a separate queue handling broadcast traffic may be implemented. In the case of broadcast traffic, the beacon is considered the trigger. The transmit bitmap is used to monitor and track the state of frame buffers ready for transmission. A bit is set in the transmit bitmap when a frame buffer is ready to be transmitted to the client (i.e. the frame has been preprocessed, etc.).

When the host has a frame to transmit, it first sends a descriptor (i.e. much shortened version of the frame) to the MAC. The MAC then examines the descriptor. If the message is to be sent to a sleeping client, the MAC may pull the frame buffer and store it internally in MAC memory. If the client is active, the MAC pulls the frame buffer since it will definitely transmit the frame as there is no need to wait for a trigger that may arrive much later.

Assuming the MAC pulled the frame for a sleeping client, the MAC first prepares the frame for transmission (i.e. performs any required preprocessing) once a trigger is received from the client (i.e. after it awakes) and then immediately releases the message. The decision whether to pull the frame buffer or wait until some other point in time is dependant on the particular implementation of the invention.

In one example, consider an algorithm wherein the MAC buffers up to two frames for high priority traffic and wherein the total number of buffered packets for a sleeping client may not exceed some predetermined limit. Note that the actual limit may be determined dynamically at run time whereby the value depends on the total number of clients connected and the total memory available in the MAC for storing frame buffers. In addition, a cache of frame buffers and descriptors are dedicated to active clients and urgent traffic (i.e. high priority QoS or management traffic).

This scheme avoids any denial of service which would happen if many sleeping clients consume all available buffer memory and the MAC cannot store any frames for active clients. Since the host does not distinguish between active and sleeping clients, the cache approach can be implemented using an attrition algorithm, wherein the MAC scans all descriptors. If the number of descriptors for sleeping clients exceeds a particular limit, the oldest descriptor for a sleeping client is discarded, thereby making room to store frame buffers destined to active clients.

Note that, preferably, the MAC memory should comprise enough frame buffers to allow a smooth flow of frames to the client. For example, the following scenario may be experienced when buffering one frame for a sleeping client (assume it has two additional descriptors ready). A trigger arrives and the MAC schedules the buffered frame for transmission. At the same time it also starts to pull frame buffers from other client descriptors. The communication bus between the host and the MAC, may, however, become congested creating a time delay from the end of transmission of the previously buffered frame until the second frame (i.e. just pulled frame) is ready to be sent out to the client. This time delay causes the client to wait and waste battery power.

In addition to storing frame buffers in MAC memory on behalf of sleeping clients, the mechanism of the invention further minimizes the response time by providing a very efficient scheme for identifying a packet that is ready for transmission. The MAC is operative to manage a plurality of queues (i.e. more than 256 in a WLAN system with 64 clients and QoS implemented). Once a trigger arrives to the MAC, it must very quickly locate a frame buffer ready to transmit to utilize next available transmission slot.

The mechanism uses active service period bitmaps (ASPBs) to effectively manage the inventory of ready frames. A ready frame being defined as a frame buffer ready for transmission or some other operation, such as transfer from the host memory into that of the MAC, wherein the corresponding client is either active or has sent a trigger to the server. Each bit in the bitmap corresponds to a single transmission queue. The ASPB provides a quick way to find a frame that is ready to transmit in O(1). If a bit in the ASPB is set, it indicates that there is a frame ready for an action that the particular ASPB represents. Thus, if a particular ASPB represents frames ready to transmit, a set bit indicates that there is a frame in the queue that is completely ready for transmission (i.e. has undergone preprocessing, including encryption, header conversion and any other media or protocol specific processing).

One benefit of using bitmaps for tracking and monitoring is that they typically require very little memory, i.e. one bit per queue, which enables the selection of frames for transmission in O(1). Considering that most modern embedded MAC processors have special instructions that can determine the MSB in a 32-bit register within a single instruction cycle, the O(1) time is indeed a very small number of CPU cycles.

Thus, the MAC processing may be considered split into three stages: (1) the transfer (XFR) stage wherein the frame buffer is pulled from the host based on the descriptor; (2) frame preprocessing wherein once the frame is in MAC memory, it is prepared for transmission, e.g., encryption, header addition and other protocol specific actions performed; and (3) the preprocessed frame then awaits a transmission opportunity (i.e. waits for a trigger from the client).

The scheme of buffering frames within the MAC memory is operative to prevent the occurrence of DoS. It is noted that the decision whether to pull a frame from the host memory for a particular client may be unrelated to the number of frames for that client that are ready for transmission. This may be the case when the particular is an active client. With an active client, every frame pulled is transmitted since as the server does not have to wait for the trigger.

Consider another case wherein: (1) one to two frames destined to a particular client are ready to transmit; (2) two frames have descriptors in the MAC, but the data buffers were not transferred because a congestion avoidance algorithm running in the MAC did not allow it; and (3) a trigger arrives from the particular client and the frames ready for transmission are scheduled for the next TX slots. Note that the trigger indicates that the client is awake and additional frames can be sent to it. In this case, the MAC has sufficient time to transfer and transmit additional frames for that particular client.

The above scenario allows more frames to be pushed to a client during the period it is awake and thus enables sustaining higher throughputs with relatively little cost in terms of battery life. It is noted that the most battery drain occurs on wake-up and during transmission, not during reception.

To facilitate this scheme, the invention provides two ASPBs, namely (1) the transfer or XFR-ASPB for monitoring the state of descriptors and (2) the transmit or TX-ASPB for monitoring the state of buffers ready to transmit.

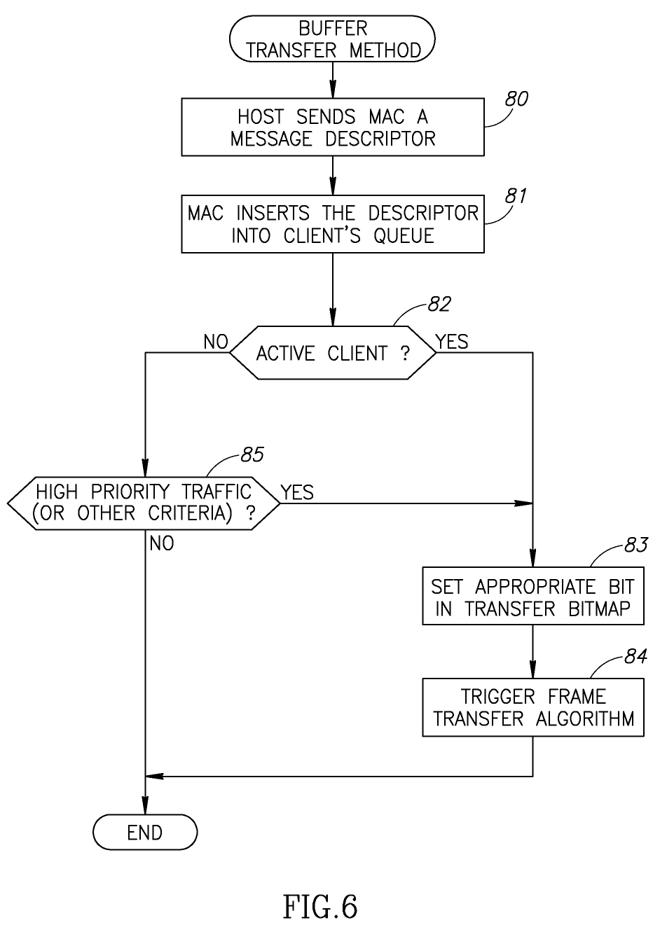

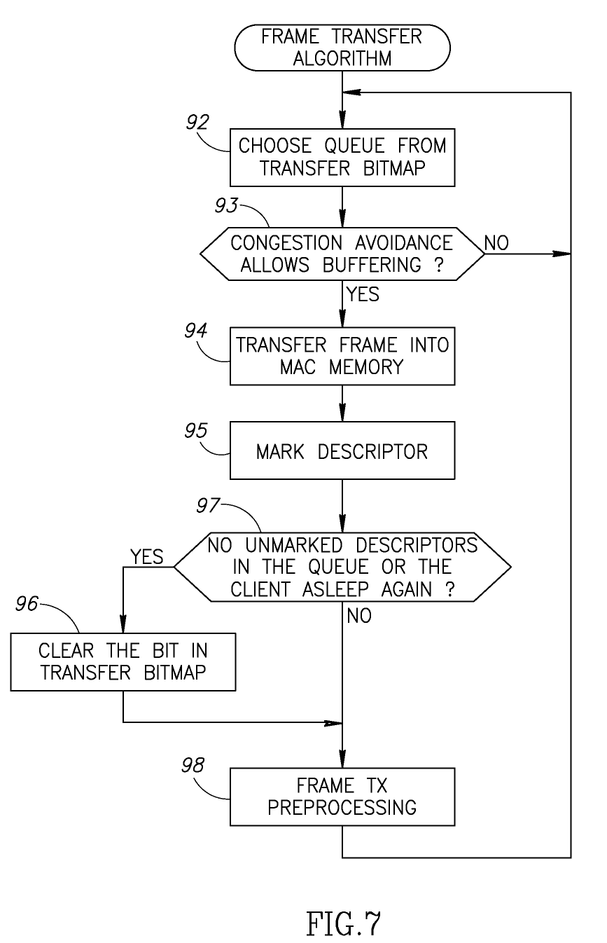

A flow diagram illustrating the method of the present invention for transferring buffers from the host to the MAC is shown in FIG. 6. When the host has a frame to transmit, it sends the MAC a descriptor of the frame (step 80). Each new descriptor received by the MAC is queued into its respective queue in MAC memory (step 81). If the descriptor belongs to an active client (step 82), the corresponding bit is set in the transfer bitmap (step 83) and a frame transfer scheduler is triggered (step 84). If the client is asleep, the MAC may still set the bit in the transfer bitmap based on implementation specific criteria (step 85). In an example embodiment, high-priority traffic is buffered in order to minimize response time. Additional criteria may allow buffering of low-priority traffic streams in the event the number of frames received from the stream exceeds a certain threshold.

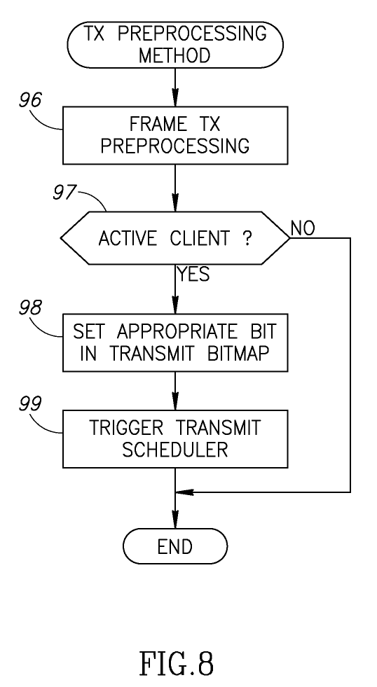

A flow diagram illustrating the frame transfer method of the present invention is shown in FIG. 8. The transfer scheduler selects frames to buffer in accordance with bits set in the transfer bitmap (step 92). Note that any suitable scheduling algorithm may be used with the mechanism of the invention. If the congestion avoidance algorithm does not block the transfer (step 93), the selected frames are then transferred from the host to the MAC (step 94). At this point, the frame is no longer relevant for purposes of the transfer scheduler and its descriptor is marked, the actual implementation of which is not critical to the invention) (step 95). If no additional unmarked frames remain in the queue or the client returned to sleep (step 97), the MAC resets the bit in the transfer bitmap (step 96). This step avoids unnecessary delays when selecting the next candidate frame to transfer.

The frame is sent to TX pre-processing for header conversion, encryption, etc. (step 98). As long as there are queues that the transfer scheduler did not scan (i.e. bits set in transfer bitmap) the transfer scheduler is triggered again to maximize the number of frames it transfers (most likely from different set of queues, dependant on scheduler implementation). Note that the running time for this method is O(1), as the number of queues to scan is limited and queue selection is performed using a relatively small number of instructions (e.g., fast bit manipulation instructions). This method results in the minimization of frame transfer time and allows better utilization of the service period by either minimizing latency between frame transmissions or packing more frames into a single service period.

A flow diagram illustrating the frame TX preprocessing method of the present invention is shown in FIG. 8. Once a frame is buffered in MAC memory, it is preprocessed to prepare it for transmission in advance (step 96). Once preprocessing is complete, a corresponding bit in the transmit bitmap is set (step 98) for active clients only (step 97). Once the MAC has a frame ready for transmission, it triggers the transmission scheduler (step 99). Note that the transmission scheduler is not triggered if the transfer bitmap is empty.

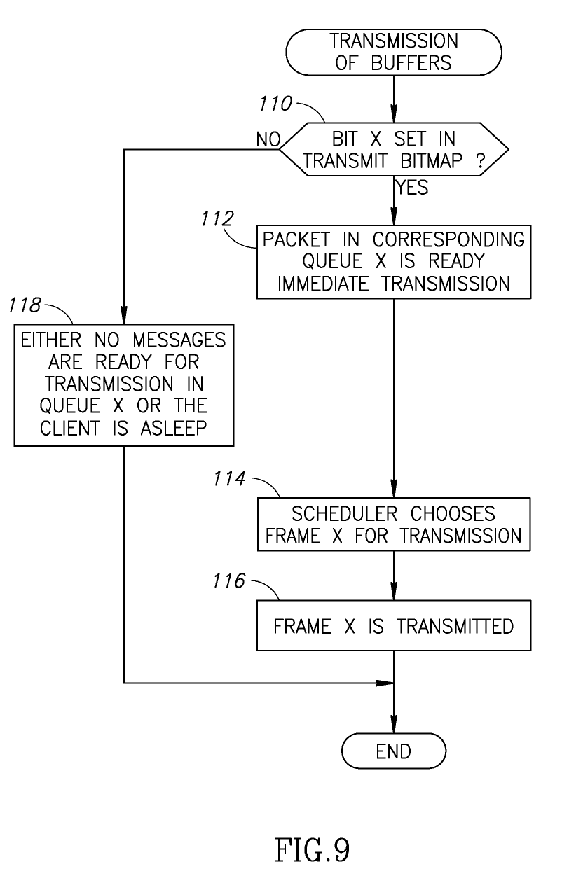

A flow diagram illustrating the buffer transmission method of the present invention is shown in FIG. 9. It is first checked whether there are any bits set in the transmit bitmap (step 110). A bit X set in the transmit bitmap indicates that a frame buffer in corresponding queue X is ready for immediate transmission. Note that with use of the transmit bitmap, the MAC is not concerned with the active/sleeping state of a client. If bit X is not set, then this indicates either (1) that there are no messages ready for transmission in queue X or (2) that the client (to whom packets from queue X are destined) is asleep (step 118). Note that queue X may have descriptors or even frame buffers, but as long as the buffer is not zero-delay ready for transmission, the bit in the transmit bitmap remains cleared. This ensures that frames selected for transmission are not delayed due the frame not being ready.

If bit X is set (step 110), then the frame in corresponding queue X is ready for immediate transmission (step 112). The schedule or other task or circuit selects frame X for transmission (step 114). Frame X is then transmitted to the client (step 116).

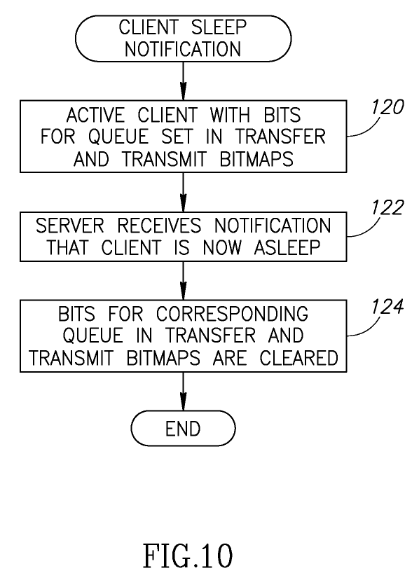

A flow diagram illustrating client sleep notification method of the present invention is shown in FIG. 10. Consider the case of an active client. This client has bits for its queues set in both the transfer and transmit bitmaps (step 120). This means (1) it has at least one descriptor whose frame buffer is to be transferred from the host to the MAC and (2) it has frame buffers ready to transmit. At this moment in time, however, the client sends a notification to the server informing the server that it is going to sleep (step 122). In this case, the server must avoid buffering additional frames for this client in order to avoid any DoS. The MAC is operative in this case to handle such notifications and to turn off corresponding bits in both the transfer and transmit bitmaps (step 124). Note, however, that bits in the transfer bitmap can remain set if the frame traffic is high priority.

### Example WLAN Access Point

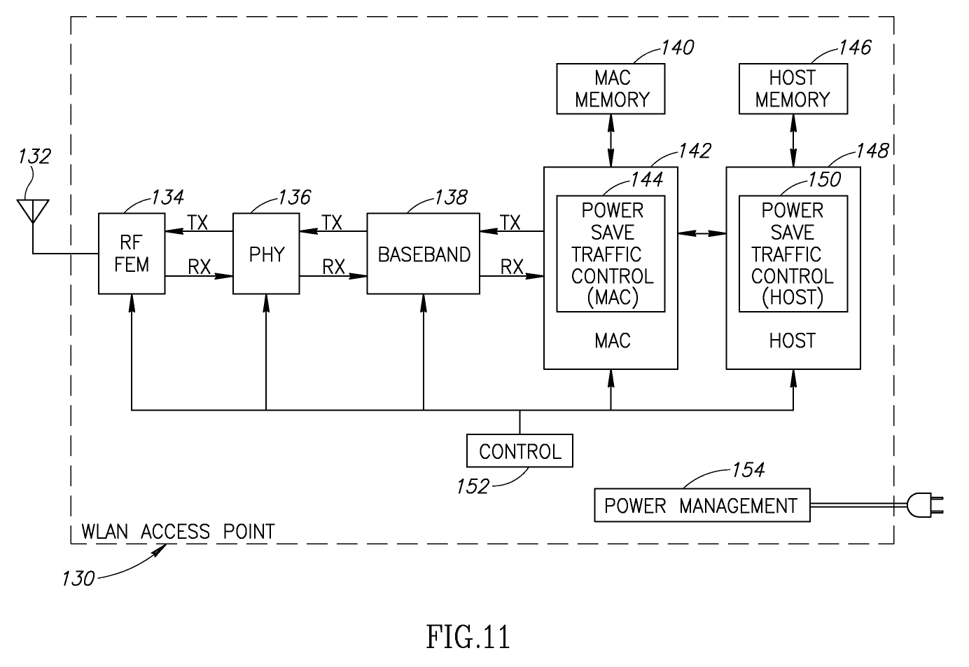

A block diagram illustrating an example WLAN access point incorporating the power save traffic control mechanism of the present invention is shown in FIG. 11. The WLAN access point, generally referenced 130, comprises an RF front end module (FEM) 134, PHY circuit 136, baseband processor 138, MAC processor 142, MAC memory 140, host processor 148, host memory 146, controller 152, power management 154 and antenna 132. The MAC processor is operative to implement the MAC portion 144 of the power save traffic control mechanism of the invention. The host processor is operative to implement the host portion 150 of the power save traffic control mechanism of the invention. The RF FEM comprises the RF switch, bandpass filter, RF front end circuitry, bandpass filter, etc. The PHY circuit comprises I and Q signal analog to digital converters (ADCs) and I and Q signal digital to analog converters (DACs) (not shown). The memory 140, 146 comprises any required memory devices such as EEPROM, RAM, ROM, FLASH memory, etc. necessary for operation of the MAC processor. Note that in one embodiment, the mechanism of the invention is implemented as firmware/software that resides in memory 140 and executes on the MAC processor or other controller device.

The RF front end circuit with the radio functions to filter and amplify RF signals and perform RF to IF conversion to generate I and Q data signals for the ADCs and DACs in the PHY. The baseband processor functions to modulate and demodulate I and Q data, perform carrier sensing, transmission and receiving of frames. The media access controller (MAC) functions to control the communications (i.e. access) between the host and applications. The power management circuit 154 is adapted to receive power via a wall adapter, battery and/or other means such as an interface (not shown). The interface may comprise PCI, Ethernet, CardBus or USB interfaces.

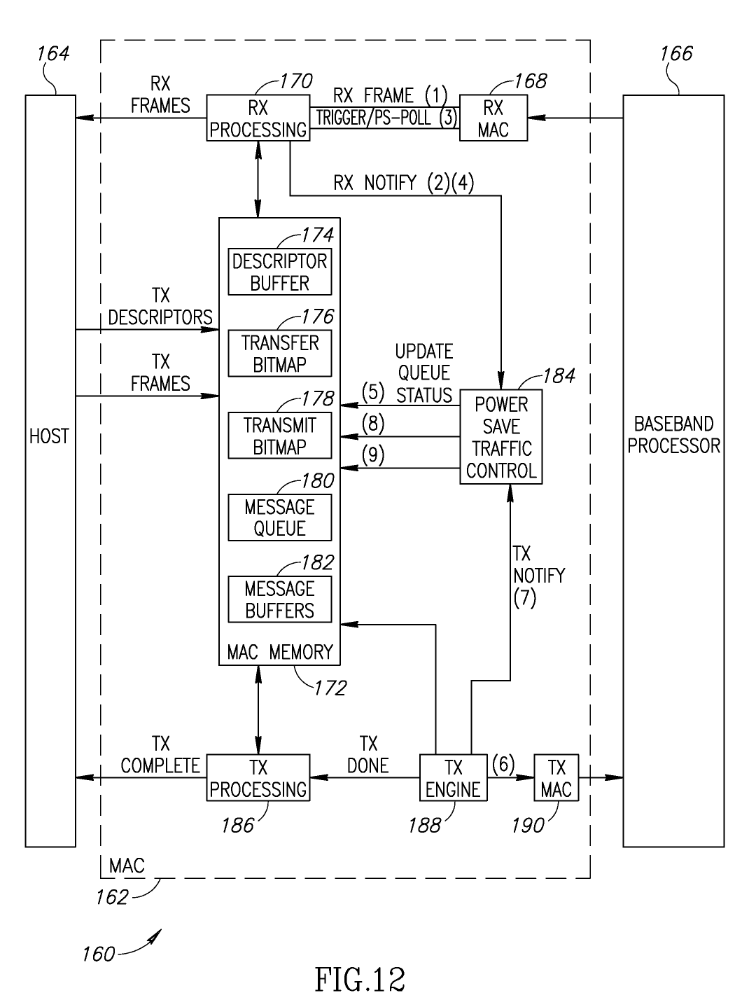

A block diagram illustrating the MAC portion of the WLAN access point of FIG. 11 in more detail is shown in FIG. 12. The circuit, generally referenced 160, comprises a MAC 162 in communication with both the host 164 and the baseband processor 166. The MAC comprises an RX MAC block 168, RX processor block 170, TX MAC 190, TX engine 188, TX processing 186, memory 172 and the power save traffic control block 184. The memory comprises a descriptor buffer 174, transfer bitmap 176, transmit bitmap 178, message queues 180 and message buffers 182.

### MAC Operation Flow

The reference to FIG. 12, the operation flow of the MAC will now be described. The MAC receives a notification from a STA that the STA is entering power save mode (referenced #1). The power save traffic control module 184 updates the STA status (in a STA context data base) to indicate it is in power save and clears any corresponding bits in the transfer and transmit bitmaps (referenced #2). Meanwhile, the host may have transferred descriptors for the STA to the MAC. At some point in time, a trigger or PS-Poll is received from the STA requesting to receive frames buffered for it by the access point (referenced #3).

The RX processing component 170 notifies the traffic control block 184 for each received descriptor frame (referenced #4). This notification is used for two purposes: (1) to update the power save mode per STA in the STA context data base; and (2) to update the service period indication of the corresponding power save type in the STA context data base. At this time, the traffic control 184 makes a determination whether to set the bits in the transfer bitmap corresponding to the received descriptors.

At the start/end of the service period, the traffic control module 184 updates the service period indication of the corresponding power save type in the STA context data base and updates the status bit field of the corresponding queue (referenced #5). The affected TX queues are those queues that are configured to be triggered by the received trigger. The frame buffers for the selected descriptors are pulled from the host in accordance with the transfer bitmap. Pulled frame buffers are then preprocessed and the corresponding bits in the transmit bitmap are set to indicate frames ready to transmit. The TX engine schedules frames from all queues in the service period. Scheduling on ready frames is performed by selecting frames from queues with corresponding bits set in TX-ASPB.

The TX engine then transmits the selected frame (referenced #6). Once acknowledged, the TX engine notifies the traffic control module that a frame for a specific STA and from a specific queue was sent (referenced #7). In case there are no more frames ready for immediate transmission, the traffic control resets the corresponding bit in the transmit bitmap (referenced #8). In addition, the traffic control module updates the service period status for that specific STA and in case of “end of service period” marks the relevant STA TX queues to indicate “out of service period”. The end of service period marks the start of the sleep stage of a power save enabled client. The corresponding bits in the TX-ASPB and the XFR-ASPB are reset depending on the presence of a high-priority stream (referenced #9).

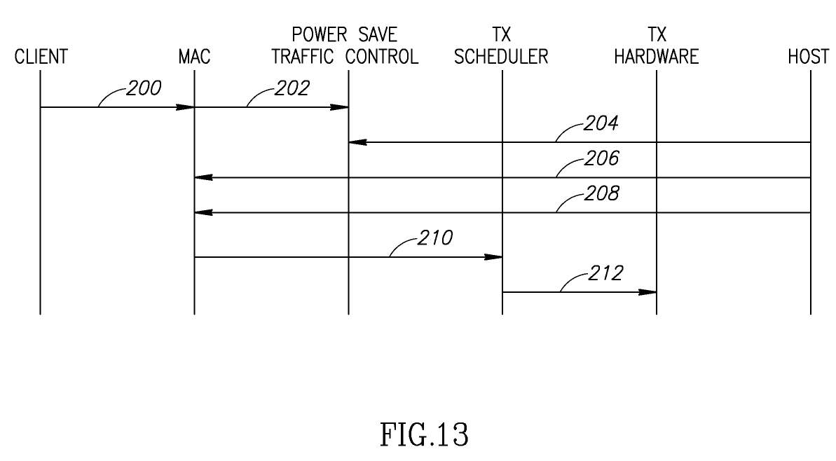

Several examples of operation flow for clients (STAs) in different scenarios are presented below. A diagram illustrating the message flow in the case of an active client is shown in FIG. 13. The flow between the client (STA in WLAN systems), host, power save traffic control mechanism in the MAC, TX schedule and TX hardware is presented. A trigger (referenced 200) received from the client is passed to the traffic control mechanism (referenced 202) to indicate that the client has awoken from power save mode. The host sends one or more descriptors to the traffic control mechanism (referenced 204). Since the client is currently active, the corresponding bits in the transfer bitmap are set and frame buffers are pulled from the host (referenced 206, 208). The traffic control mechanism preprocesses the frame buffers and sets the corresponding bits in the transmit bitmap. The processed frame buffers are selected by the TX scheduler (referenced 210) where they are programmed for transmission to the client via the TX hardware (referenced 212).

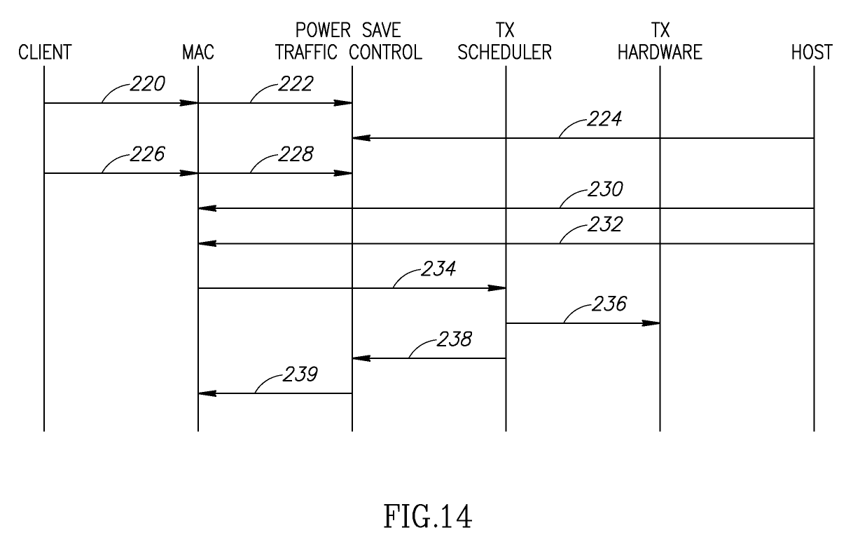

A diagram illustrating the message flow in the case of a sleeping client and low priority flow is shown in FIG. 14. Since the flow in this example is low priority, the traffic control mechanism does not set any bits in the transfer or transmit bitmap. A notification that the client is going to sleep is sent from the client to the host (referenced 220) and passed to the traffic control mechanism (referenced 222). Although the host sends one or more descriptors to the traffic control mechanism (referenced 224), the traffic control mechanism does not pull the frame or perform any preprocessing until a trigger is received from the client.

Once the trigger is received, indicating that the client is not in sleep mode anymore (reference 226, 228), the traffic control mechanism sets the appropriate bits in the transfer bitmap and pulls the frames from the host (referenced 230, 232). Since the client is now active, the traffic control mechanism preprocesses the frame buffers and sets the corresponding bits in the transfer bitmap. Once TX preprocessing is performed on the frame, the corresponding bit in the transmit bitmap is set. The processed frame buffers are selected by the TX scheduler (referenced 234) where they are scheduled for transmission to the client via the TX hardware (referenced 236). The traffic control mechanism is notified for every frame transmitted by the TX scheduler (referenced 238). Once the service period ends, the traffic control mechanism clears the corresponding bits in the transfer and transmit bitmaps (referenced 239).

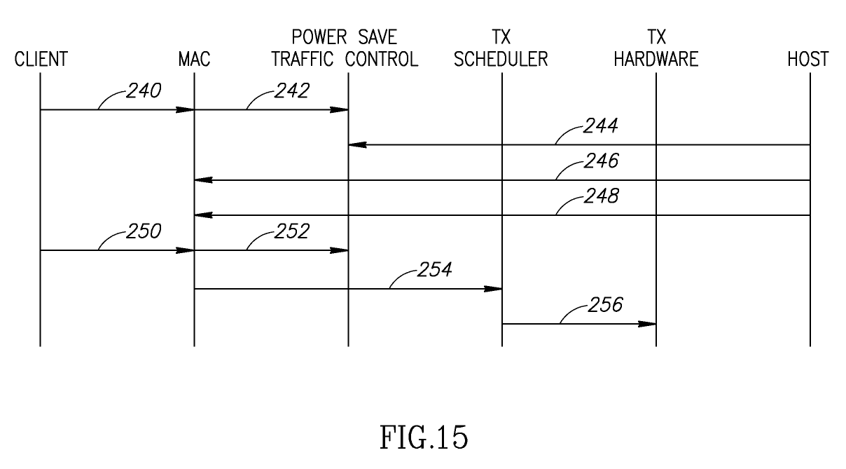

A diagram illustrating the message flow in the case of a sleeping client and high priority flow is shown in FIG. 15. In this example, the flow is high priority, thus the traffic control mechanism sets bits in the transfer bitmap but waits for a trigger before setting any bits in the transmit bitmap. A notification that the client is going to sleep is sent from the client to the server (referenced 240) and passed to the traffic control mechanism (referenced 242). The traffic control mechanism clears corresponding bits in the transmit bitmap and bits corresponding to low priority bits in the transfer bitmap. The host sends one or more descriptors to the traffic control mechanism (referenced 244) and the traffic control mechanism pulls the frame, basing its decision whether to pull a frame on the priority of the stream or on other criteria in addition to the decision of the congestion avoidance algorithm. The traffic control mechanism performs preprocessing on the frame but does not set any corresponding bits in the transmit bitmap (referenced 246, 248). The traffic control mechanism waits until a trigger is received from the client.

Once the trigger is received indicating that the client is not in sleep mode anymore (referenced 250, 252), the traffic control mechanism sets the appropriate bits in the transmit bitmap. Since the client is now active, the traffic control mechanism sets the corresponding bits in the transfer bitmap. As there are frames ready for immediate transmission to the client, it also sets corresponding bits in the transmit bitmap. The processed frame buffers are selected by the TX scheduler (referenced 254) where they are programmed for transmission to the client via the TX hardware (referenced 256).

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of traffic control during power save in a system of a plurality of power save enabled client devices and a server, said server having a host and a media access control (MAC), said method comprising the steps of:
receiving descriptors on said MAC sent from said host, wherein each descriptor identifies a frame stored on said host and a client associated therewith; and
utilizing a bitmap in said MAC to indicate the frames to be retrieved from said host and the transferred frames ready to be transmitted to a client.

2. The method according to claim 1, wherein frames retrieved from said host are stored in a frame buffer.

3. The method according to claim 1, wherein frames stored in frame buffers are preprocessed to prepare them for transmission while clients corresponding thereto are asleep.

4. A method of power save traffic control in a system of a plurality of power save enabled client devices and a server, said server having a host and a media access control (MAC), said method comprising the steps of:
receiving frame descriptors from said host, wherein each frame descriptor identifies a frame stored on said host and a client associated therewith; and
transferring from said host to said MAC a predetermined number of frames corresponding to received frame descriptors for sleeping clients and storing them in frame buffers;
transferring from said host to said MAC a sufficient number of frames corresponding to received frame descriptors for active clients to provide a continuous flow of frames thereto and storing them in said frame buffer; and
utilizing a bitmap to indicate which client queues have frame buffers ready to transmit.

5. The method according to claim 4, further comprising the step of indicating via a transfer bitmap the client queues with frames to be transferred from said host to said MAC.

6. The method according to claim 4, wherein frame buffers ready to transmit are transmitted only to active clients corresponding thereto.

7. A method of minimizing traffic congestion in a system of power save client devices in communication with a server, said method comprising the steps of:
receiving shortened message descriptors from said host and storing them in respective MAC queues, wherein each message descriptor identifies a buffer stored on said host and a client device associated therewith;
indicating via a transfer bitmap the client queues with buffers to be transferred from said host to said MAC;
transferring buffers from said host to said MAC in accordance with said transfer bitmap and storing them in MAC memory;
processing contents of said buffers to yield processed buffers ready for transmission; and
indicating via a transmit bitmap the client queues having buffers ready to transmit.

8. The method according to claim 7, wherein said step of transferring comprises the step of transferring a predetermined number of received message descriptor buffers for sleeping clients.

9. The method according to claim 7, wherein said step of transferring comprises the step of transferring a sufficient number of received message descriptor buffers for active clients to provide a continuous flow of messages thereto.

10. The method according to claim 7, wherein respective bits in said transfer bitmap are cleared for low priority streams of sleeping clients.

11. The method according to claim 7, wherein respective bits in said transfer bitmap are cleared when no unmarked descriptors remain in a client queue corresponding thereto.

12. The method according to claim 7, wherein respective bits in said transfer bitmap are set for high priority streams of sleeping clients.

13. The method according to claim 7, wherein respective bits in said transfer bitmap are set for active clients.

14. The method according to claim 7, further comprising the step of setting a respective bit in said transmit bitmap upon receiving a trigger from a previously sleeping client device if descriptors are present in a queue corresponding thereto that are ready for immediate transmission.

15. The method according to claim 7, further comprising the step of scheduling transmission of buffers ready to transmit.

16. A media access control (MAC) for use in a base station server in communication with a plurality of power save enabled client devices, comprising:
a transfer bitmap for storing indications of client queues for which buffers are to be transferred from a host;
a transmit bitmap for storing indications of client queues having buffers ready to transmit;
a plurality of frame buffers for storing complete frames;
a power save traffic congestion module operative to:
receive shortened message descriptors from said host, wherein each message descriptor identifies a buffer stored on said host and a client associated therewith;
update said transfer bitmap in accordance with the message descriptors received and the status of each client corresponding thereto;
retrieve client queue buffers from said host in accordance with the bits set in said transfer bitmap and storing them in said frame buffers;
preprocess buffers retrieved from said host in preparation for transmission; and
update said transmit bitmap in accordance with the preprocessed buffers ready to transmit.

17. The MAC according to claim 16, further comprising means for scheduling frame buffers for transmission in accordance with said transmit bitmap.

18. The MAC according to claim 16, further comprising means for transmitting frame buffers for client queues whose corresponding bit is set in said transmit bitmap, once a trigger is received from the respective client indicating it is in an active state.

19. The MAC according to claim 16, wherein said power save traffic congestion module is operative to retrieve a predetermined number of received message descriptor buffers for sleeping clients.

20. The MAC according to claim 16, wherein said power save traffic congestion module is operative to transfer a sufficient number of received message descriptor buffers for active clients so as to provide a continuous flow of messages thereto.

21. The MAC according to claim 16, wherein respective bits in said transfer bitmap are cleared for low priority streams of sleeping clients.

22. The MAC according to claim 16, wherein respective bits in said transfer bitmap are set for high priority streams of sleeping clients.

23. The MAC according to claim 16, wherein respective bits in said transfer bitmap are set for active clients.

24. The MAC according to claim 16, further comprising the step of setting a respective bit in said transmit bitmap upon receiving a trigger from a previously sleeping client.

25. A wireless access point, comprising:
a radio frequency (RF) front end circuit coupled to an antenna;
a PHY circuit coupled to said RF front end circuit;
a baseband processor coupled to said PHY circuit;
a media access control (MAC) coupled to said baseband processor, said MAC comprising:
means for receiving shortened message descriptors from a said host, wherein each message descriptor identifies a buffer stored on said host and a client associated therewith;
means for updating a transfer bitmap in accordance with the message descriptors received and the status of each client corresponding thereto;
means for retrieving client queue buffers from said host in accordance with the bits set in said transfer bitmap and storing them in frame buffers;
means for preprocessing buffers retrieved from said host in preparation for transmission;
means for updating a transmit bitmap with said preprocessed buffers ready to transmit; and
said host operative to interface said access point to an external network.

26. The access point according to claim 25, wherein said external network comprises an Ethernet network.

27. The access point according to claim 25, wherein said RF front end circuit, said PHY circuit, said baseband processor, said MAC and said host are operative to implement a Wireless Local Area Network (WLAN) standard.

28. The access point according to claim 25, wherein said MAC further comprises means for scheduling frame buffers for transmission in accordance with said transmit bitmap.

29. The access point according to claim 25, wherein said MAC further comprises means for transmitting frame buffers for client queues whose corresponding bit is set in said transmit bitmap, once a trigger is received from the respective client indicating it is in an active state.
